(19) United States
(12) Patent Application Publication
(10) Pub. No.: US 2016/0018096 A1
(43) Pub. Date: Jan. 21, 2016

(54) HEAT DISSIPATION STRUCTURE FOR LED EXPLOSION-PROOF LAMP

(71) Applicant: Li-Hong Science & Technology Co., Ltd., Kaohsiung City (TW)

(72) Inventors: Ming-Tien Chien, Kaohsiung City (TW); Ching-Yuan Juan, Kaohsiung City (TW); Yi-Hung Juan, Kaohsiung City (TW); Han-Wen Chang, Kaohsiung City (TW); Cheng-Lung Juan, Kaohsiung City (TW)

(21) Appl. No.: 14/523,384

(22) Filed: Oct. 24, 2014

(30) Foreign Application Priority Data
Jul. 15, 2014 (TW) 103124325

(51) Int. Cl. F21V 29/83; F21V 29/507; F21V 29/74

(52) U.S. Cl. CPC F21V 29/83; F21V 29/74; F21V 29/507; F21Y 2101/02

(57) ABSTRACT

A heat dissipation structure for an LED explosion-proof lamp includes an illumination module, a heat conduction disk, a window frame shell and a lamp set shell. The illumination module includes a base and at least one light-emitting diode. The heat conduction disk includes a plurality of installation holes. The window frame shell includes a light permeable portion, a window frame and a plurality of window frame connection holes. The lamp set shell includes a casing portion and a plurality of lamp set connection holes. Each compact member presses and holds the window frame shell and the lamp set shell. The heat conduction disk has a heat conduction zone formed on a projection location of the window frame shell and the lamp set shell, and a cooling zone encircled the heat conduction zone at an outer side to perform heat exchange with external air.

### FIELD OF THE INVENTION

The present invention relates to a LED explosion-proof lamp heat dissipation structure and particularly to a LED explosion-proof lamp heat dissipation structure that provides improved cooling efficacy and also is explosion proof.

### BACKGROUND OF THE INVENTION

Light-emitting diode (LED in short hereinafter) has many advantages, such as smaller size, faster response speed, longer lifespan and the like. In the past LED mainly is used as the light source of backlight panels of screens. Upon constant research and improvement, now illumination lamp sets using the LED as the light source have been developed. However, the lifespan of LED significantly shortens under high temperature. When the LED is in use it generates waste heat which cannot be dispersed through infrared ray radiation, but can only be dispersed through conduction. Hence the general LED lamp set usually is connected to heat conductive material to reduce thermal resistance to conduct the waste heat outside the lamp set. When the LED is used in an explosion-proof lamp set, to avoid high temperature generated by explosion of electric devices in the lamp set to ignite inflammable gases outside the lamp set, the space in the lamp set must be sealed. This makes dispersion of the waste heat even more difficult.

Taiwan Patent No. M461751 discloses a LED lamp set and heat conductive apparatus thereof. It provides at least one heat conductive apparatus which includes at least one base and a circuit substrate layer located on a heat conductive substrate. The circuit substrate has at least one LED located thereon. The heat conductive substrate has a connecting portion at a lower surface connected to one end of a heat conduction tube. The heat conduction tube has another end formed a fastening portion which fastens the heat conductive apparatus to an annular cooling fin and an inner rim formed at least one housing seat to hold the heat conductive apparatus. The annular cooling fin is shielded by a lid at the upper side. The lamp base is installed below the annular cooling fin to form a LED lamp set. By incorporating the heat conduction tube and the cooling fin cooling efficacy of the lamp set improves, and it is adaptable to various types of lamp sets.

However, the aforesaid technique uses the heat conduction tube to conduct the waste heat generated by the LED to the annular cooling fin. Due to the cooling efficacy of the cooling fin depends on its surface area, in the event that the LED of a greater power is employed the size and weight of the cooling fin also increases correspondingly. This not only increases production cost also creates space constraint. Hence it still has room for improvement. The present invention aims to provide an explosion-proof lamp heat dissipation structure with improved cooling efficiency so that the lamp set can be made at a smaller size holistically to achieve same or even better cooling efficiency than the conventional technique does.

### SUMMARY OF THE INVENTION

The primary object of the present invention is to solve the problem of the conventional technique of explosion-proof lamp set by collaborating the heat conduction tube and the cooling fin to disperse heat that results in bigger total size and overweight of the explosion-proof lamp set.

To achieve the foregoing object the present invention provides a LED explosion-proof lamp set heat dissipation structure that includes an illumination module, a heat conduction disk, a window frame shell, a lamp set shell and a plurality of compact members. The illumination module includes a base and at least one light-emitting diode (LED) located on the base. The heat conduction disk is installed on the base and has a plurality of installation holes formed along the circumference of the base. The window frame shell is located at one side of the illumination module where the LED is located, and includes a light permeable portion corresponding to each LED, a window frame encircled the light permeable portion and a plurality of window frame connection holes located on the window frame corresponding to the installation holes. The lamp set shell is located at another side of the illumination module opposite to the window frame shell, and includes a casing portion formed in contact with the heat conduction disk after assembly and a plurality of lamp set connection holes formed on the casing portion corresponding to the window frame connection holes. Each compact member runs through one window frame connection hole, one installation hole and one lamp set connection hole that correspond to each other to press and fasten the window frame shell and the lamp set shell at two opposite sides of the heat conduction disk. After the heat conduction disk is coupled with the window frame shell and the lamp set shell, a heat conduction zone is formed thereon corresponding to a projection location of the window frame shell and the lamp set shell, and a cooling zone also is formed thereon to encircle the heat conduction zone at an outer side and extended in a direction remote from the center of the heat conduction disk to perform heat exchange with external air.

In one aspect the heat conduction disk has a housing portion at one side facing the base. The housing portion includes a plurality of grooves originated from the center of the heat conduction disk and extended radially from the center thereof. The LED explosion-proof lamp heat dissipation structure further includes a plurality of heat conductive materials located in the grooves.

In yet another aspect the housing portion includes at least one curved groove which has a curved section passing through the center of the heat conduction disk.

In yet another aspect the housing portion is located in the heat conduction zone and spaced from the window frame shell to form an allowance gap.

In yet another aspect the heat conduction disk has a plurality of cooling holes encircled the heat conduction zone. Each cooling hole has a plurality of serrate notches formed on the circumference thereof.

In yet another aspect the heat conduction disk includes two panels which have respectively an indented clamp portion at one side facing the other panel. Each clamp portion includes a plurality of wedge troughs originated from the center of the heat conduction disk and extended radially from the center thereof. The LED explosion-proof lamp heat dissipation structure further includes a plurality of heat conduction materials located between the two clamp portions.

In yet another aspect each clamp portion includes at least one curved wedge trough which has a wedge trough curved section passing through the center of the heat conduction disk.

In yet another aspect each panel has a plurality of indented cooling chambers at one side faced the other panel and located in the cooling zone to encircle the heat conduction zone. The heat conduction disk has a plurality of cooling holes run through each cooling chamber. Each cooling hole has a plurality of serrate notches formed on the circumference thereof.

In yet another aspect the heat conduction disk includes two clamp panels and a spaced panel located between the two clamp panels. The spaced panel has a plurality of housing chambers run through the spaced panel and sealed by the two clamp panels. Each housing chamber is originated from the center of the heat conduction disk and extended radially from the center thereof. The LED explosion-proof lamp heat dissipation structure further includes a plurality of heat conduction materials located in the housing chambers.

In yet another aspect the spaced panel has a plurality of housing chambers run through the spaced panel and sealed by the two clamp panels and located in the cooling zone to encircle the heat conduction zone, and a plurality of cooling holes run through each cooling chamber. Each cooling hole has a plurality of serrate notches formed on the circumference thereof.

In yet another aspect the LED explosion-proof lamp heat dissipation structure further includes a plurality of expansion fins located in the cooling zone at one side of the heat conduction disk facing the lamp set shell.

In yet another aspect the heat conduction disk has a plurality of cooling holes in the cooling zone to encircle the heat conduction zone. Each cooling hole has a plurality of serrate notches formed on the circumference thereof.

Thus, compared with the conventional technique, the invention provides many advantages, notably:

1. Through the invention, waste heat generated by the LED is conducted from the base to the heat conduction disk of a greater area, and the heat conduction disk has the heat conduction zone extended outside the lamp set in contact with the air to increase cooling efficiency, thereby can replace the cooling method of the conventional explosion-proof lamp set that connects the heat conduction tube to the cooling fin at a single point fashion. In addition, the heat conduction disk extended outside the explosion-proof lamp set can have a greater external area to further enhance the cooling efficiency.

2. The lamp set shell, the heat conduction disk and the window frame shell of the invention can be pressed and coupled together to isolate the inside space and the outside space of the lamp set to conform to the international electric appliance regulations required for using in hazardous environments.

3. The heat conduction disk with the heat conduction materials added thereon can further increase waste heat conduction efficiency and lengthen flame paths to prevent generation of sparks, hence can enhance explosion proof efficacy.

4. The heat conduction disk with the cooling holes and cooling chambers formed thereon can further improve cooling efficiency. In addition, by sealing the heat conduction material through a plurality of panels, the risk of sparks in contact with inflammable gases outside the lamp set can be avoided to further improve explosion-proof effect.

The foregoing, as well as additional objects, features and advantages of the invention will be more readily apparent from the following embodiments and detailed description, which proceed with reference to the accompanying drawings. The embodiments serve merely for illustrative purpose. The drawings are made to facilitate discussion and not made in actual proportions, and shall not be deemed as the limitation of the claims of the invention.

### BRIEF DESCRIPTION OF THE DRAWINGS

FIG. 1 is an exploded view of a first embodiment of the invention.

FIG. 2A is a perspective view of the first embodiment of the invention in an assembled condition.

FIG. 2B is a sectional view taken on line 2B-2B in FIG. 2A.

FIG. 3 is a plane view of the heat conduction disk in the first embodiment of the invention.

FIG. 4A is a fragmentary exploded view of the explosion-proof lamp heat dissipation structure and the extension fins of the invention.

FIG. 4B is a sectional view taken on line 4B-4B in FIG. 4A.

FIG. 5 is an exploded view of a second embodiment of the invention.

FIG. 6A is a perspective view of the second embodiment of the invention in an assembled condition.

FIG. 6B is a sectional view taken on line 6B-6B in FIG. 6A.

FIG. 7 is a plane view of a panel of the invention.

FIG. 8 is an exploded view of a third embodiment of the invention.

### DETAILED DESCRIPTION OF THE PREFERRED EMBODIMENTS

The present invention aims to provide a LED explosion-proof lamp heat dissipation structure 1 which includes an illumination module 10, a window frame shell 20, a lamp set shell 30a, a heat conduction disk 40a and a plurality of compact members 61. The LED explosion-proof lamp heat dissipation structure 1 of the invention mainly is used as an illumination equipment in hazardous environments where inflammable gases or explosive gases are presented, such as petrochemical plants, coal production plants, and the like. However, it also can be used as an ordinary LED lamp set, and is not restrictive in applicability.

More specifically, in a first embodiment of the invention, the illumination module 10 includes a base 11 and at least one LED 12a located on the base 11. The base 11 has a circuitry (not shown in the drawings) laid thereon to form electric connection with the LED 12a. The invention can include a single LED 12a or a plurality of LEDs 12a, depending on illumination requirements.

The heat conduction disk 40a is installed on the base 11 and has a plurality of installation holes 41 formed along the circumference of the base 11 to connect to other structural elements, and can be made of metal which has a higher heat conduction efficiency and is corrosion resistant, such as 6061 aluminum alloy, 6063 aluminum alloy or the like.

The window frame shell 20 is located at one side of the illumination module 10 where the LED 12a is located, and includes a light permeable portion 21 corresponding to each LED 12a, a window frame 22 encircled the light permeable portion 21 and a plurality of window frame connection holes 23 located on the window frame 22 corresponding to the installation holes. The light permeable portion 21 can be made of light permeable material such as glass, transparent plastics or the like to allow light emitted from the LED 12a to pass through. The window frame 22 is preferably made of metal of a high heat conduction coefficient, and has the window frame connection holes 23 formed thereon to allow the window frame shell 20 to connect with other elements.

The lamp set shell 30a is located at another side of the illumination module 10 opposite to the window frame shell 20, and includes an assembly portion 31, an assembly hole 32 run through the assembly portion, a casing portion 33a in contact with the heat conduction disk 40a after assembly and a plurality of lamp set connection holes 34a formed on the casing portion 33a corresponding to the window frame connection holes 23. The assembly portion 31 can be a hanging rack, a bolt or the like to mount the LED explosion-proof lamp heat dissipation structure 1 on a wall or a ceiling for illumination. The assembly hole 32 allows an external power cord to thread through and connect to the circuitry of the base 11 to provide electric power needed by the LED 12a. In this invention the assembly hole 32 is sealed on the inner rim via a sealing element 35 such as a sealing ring to isolate the inner space of the LED explosion-proof lamp heat dissipation structure 1 from the inflammable or explosive gases in the outside environment. The casing portion 33a is preferably made of metal of a higher heat conduction coefficient and has a plurality of cooling fins 331 formed on the surface thereof in an undulate manner.

Each compact member 61 runs through one window frame connection hole 23, one installation hole 41 and one lamp set connection hole 34a that correspond to each other to press and fasten the window frame shell 20 and the lamp set shell 30a at two opposite sides of the heat conduction disk 40a. In this embodiment, the compact member 61 is a screw, and the lamp set connection hole 34a is a fastening hole with one side fastenable by the compact member 61. Each window frame connection hole 23, each installation hole 41 and each lamp set connection hole 34a are run through by one compact member 61 which tightly fastens the lamp set connection hole 34a to couple the lamp set shell 30a, the heat conduction disk 40a and the window frame shell 20 together. It is to be noted that the lamp set shell 30a, the heat conduction disk 40a and the window frame shell 20 can also be coupled and pressed together via clamping clips or riveting. The embodiment mentioned above merely serves as an example, and is not the limitation of adoptable pressing and coupling means.

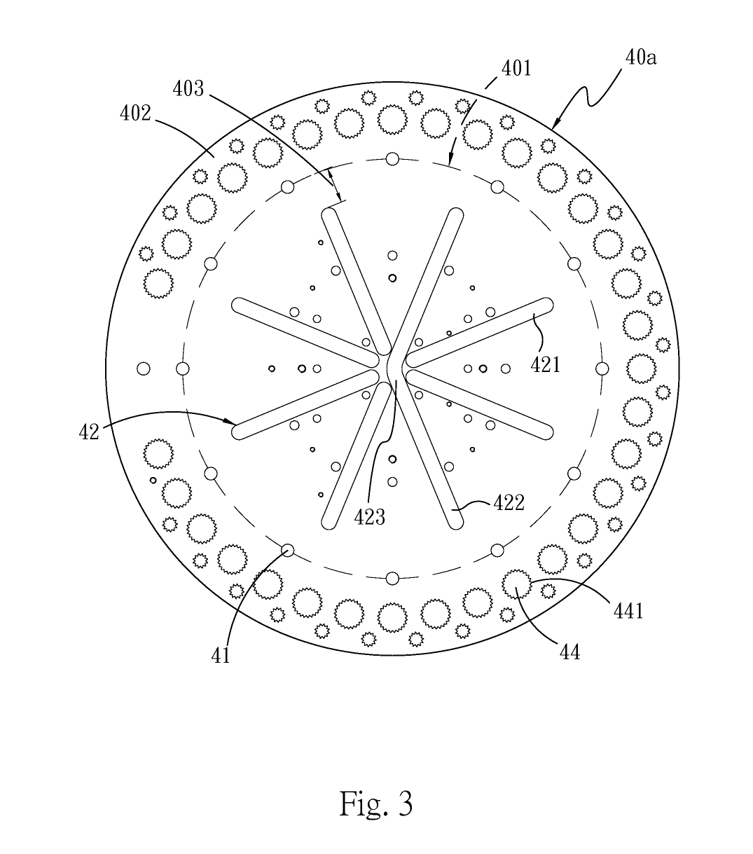

Also referring to FIG. 3, after the heat conduction disk 40a is coupled with the window frame shell 20 and the lamp set shell 30a, it has a heat conduction zone 401 formed corresponding to a projection location of the window frame shell 20 and the lamp set shell 30a, and a cooling zone 402 formed to encircle the heat conduction zone 401 at an outer side and extended from the center of the heat conduction disk 40a to perform heat exchange with external air.

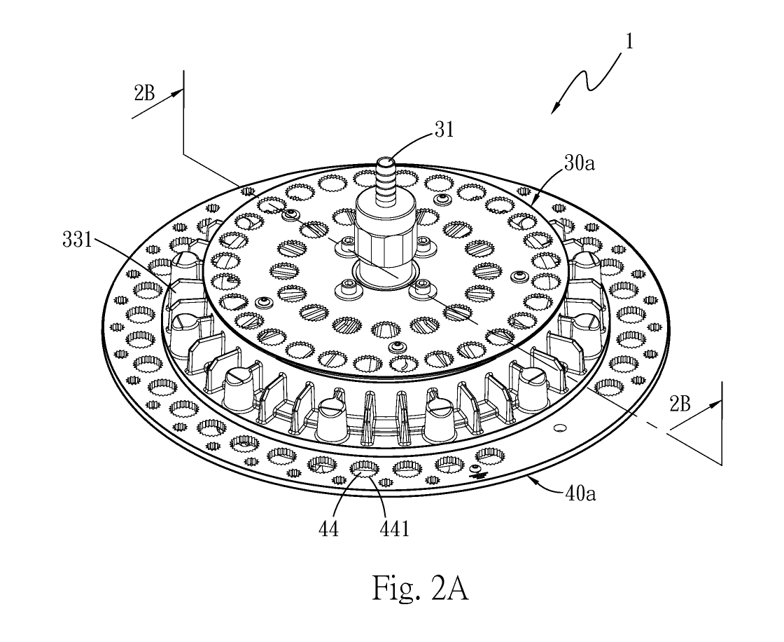

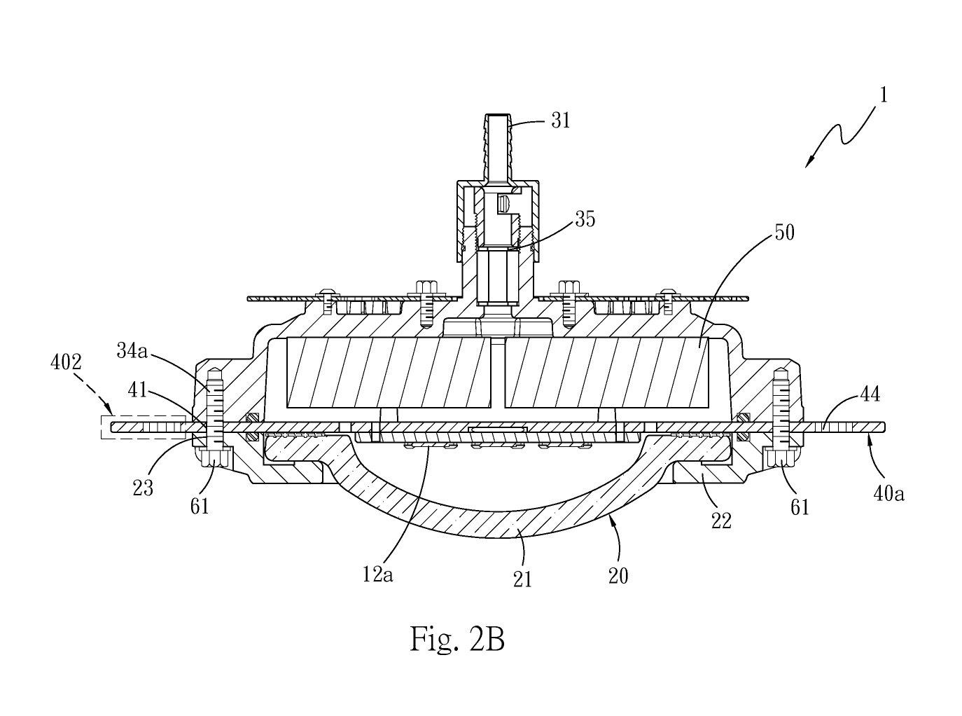

The window frame shell 20 is connected to one side of the heat conduction disk 40a where the illumination module 10 also is connected. The light permeable portion 21 is located corresponding to the LED 12a to facilitate light penetration therethrough. The lamp set shell 30a is connected to another side of the heat conduction disk 40a opposite to the window frame shell 20. The heat conduction disk 40a has a portion connected to the window frame shell 20 and the lamp set shell 30a to be defined as the heat conduction zone 401, and the heat conduction disk 40a has other portion extended outside the heat conduction zone 401 to be defined as the cooling zone 402 (referring to FIG. 2B). The cooling zone 402 conducts the heat generated by the LED 21a to facilitate rapid transmission of the waste heat generated by the LED 12a and disperse it to external air.

Thus, the waste heat generated by the LED 12a during operation can be conducted via surface contact manner from the base 11 to the heat conduction disk 40a, and the heat originally concentrated around the base 11 can be distributed to the heat conduction disk 40a of a larger area, and dispersed directly through the cooling zone 402 extended outside to the air to increase cooling efficiency, and also achieve explosion proof effect.

In another embodiment, the LED explosion-proof lamp heat dissipation structure 1 further includes an electric control unit 50 located between the heat conduction disk 40a and the lamp set shell 30a. The electric control unit 50 is electrically connected to the LED 12a. The casing portion 33a has reserved a specific space to hold the electric control unit 50 which has circuits for voltage stabilization and current rectification. It is connected to an external power source through the assembly hole 32 to regulate output voltage and provide electric power to the connected LED 12a for operation thereof.

In yet another embodiment the heat conduction disk 40a has a housing portion 42 at one side facing the base 11. The housing portion 42 includes a plurality of grooves 421 originated from the center of the heat conduction disk 40a and extended radially from the center thereof. The LED explosion-proof lamp heat dissipation structure 1 further includes a plurality of heat conduction materials 70 located in the grooves 421. The housing portion 42 also includes at least one curved groove 422 which has a curved section 423 passing through the center of the heat conduction disk 40a. The heat conduction materials 70 are made of high purity copper. The waste heat generated by the LED 12a can be conducted quicker and more evenly through the heat conduction materials 70 to the heat conduction disk 40a in a dispersed manner. The curved section 423 passes through the center of the heat conduction disk 40a corresponding to the base 11, namely, a spot on the heat conduction disk 40a at the highest temperature. Hence through the heat conduction materials 70 the waste heat can be conducted and dispersed more efficiently and widely to the heat conduction disk 40.

Furthermore, in order to avoid sparks generated by the lamp set due to unstable power supply or circuitry malfunction in contact with external inflammable gases and incur hazard, the housing portion 42 and the heat conduction materials 70 are located in the heat conduction zone 401. The housing portion 42 located in the heat conduction zone 401 also forms an allowance gap 403 spaced from the window frame shell 20 to avoid a crevice formed between the window frame shell 20 and the heat conduction zone 401. The heat conduction materials 70 can extend the flame paths widely on the heat conduction disk 40a. Hence when the LED explosion-proof lamp heat dissipation structure 1 has generated high temperature gases inside the heat conduction materials 70 can quickly disperse the heat of the high temperature gases and cool them down to suppress generation of sparks through their characteristics of lower thermal resistance and shorter heat transmission time. In addition, due to the heat conduction materials 70 are located in the heat conduction zone 401, even if sparks are generated they do not in contact with the external inflammable or explosive gases, therefore can achieve explosion proof effect.

In addition, in order to get even better cooling effect, the heat conduction disk 40a further has a plurality of cooling holes 44 encircled the heat conduction zone 401. Each cooling hole 44 has a plurality of serrate notches 441 on the circumference thereof that can increase the surface area of the heat conduction disk 40a to improve cooling efficiency. The serrate notches 441 have pointed spots formed on the heat conduction disk 40a that also can speed up heat dissipation.

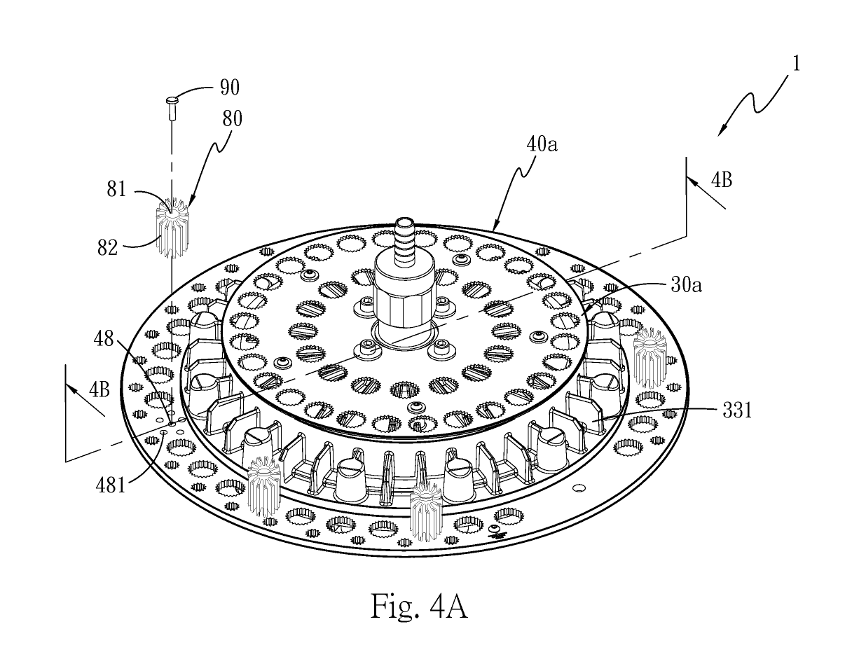

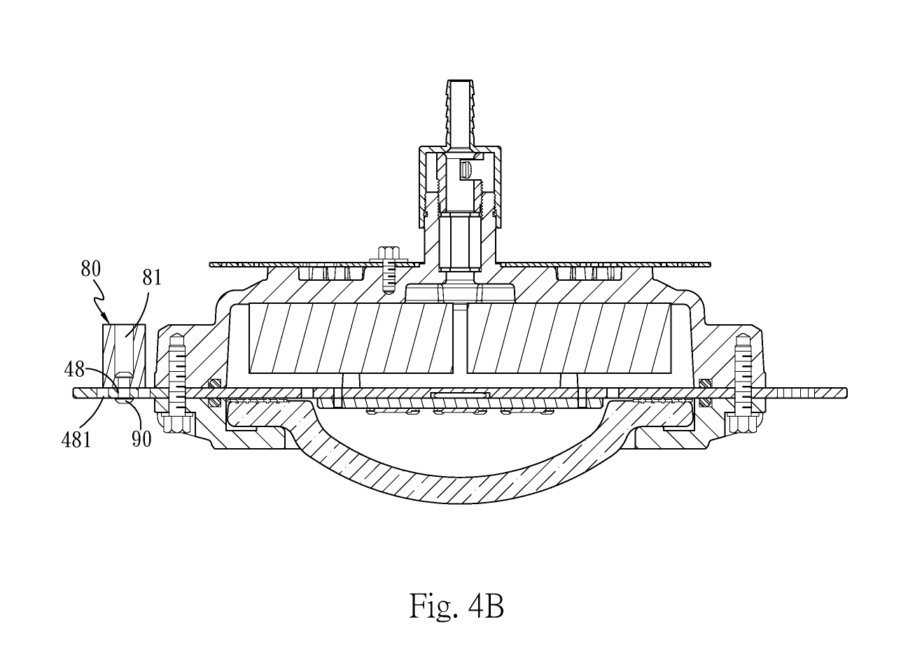

Also referring to FIGS. 4A and 4B, in the event that to improve cooling efficiency without increasing the area of the heat conduction disk 40a is given condition, the LED explosion-proof lamp heat dissipation structure 1 can further include a plurality of expansion fins 80 located at one side of the heat conduction disk 40a facing the lamp set shell 20 (referring to FIG. 2B) and also located in the cooling zone 402. In this embodiment each expansion fin 80 has a fin connection hole 81, and the heat conduction disk 40a has a plurality of anchor holes 48 each is fastened to the fin connection hole 81 by running through a fastener such as a rivet 90. A plurality of fin cooling holes 481 may also be formed around each anchor hole 48 to increase the surface area of the expansion fins 80 to further improve cooling efficiency.

In the various embodiments of the invention elements of same name and same structure are given same notations, while elements of same name but different structure are given different notations. The elements of the second embodiment are substantially same as that of the first embodiment, the differences of the embodiments are discussed as follows:

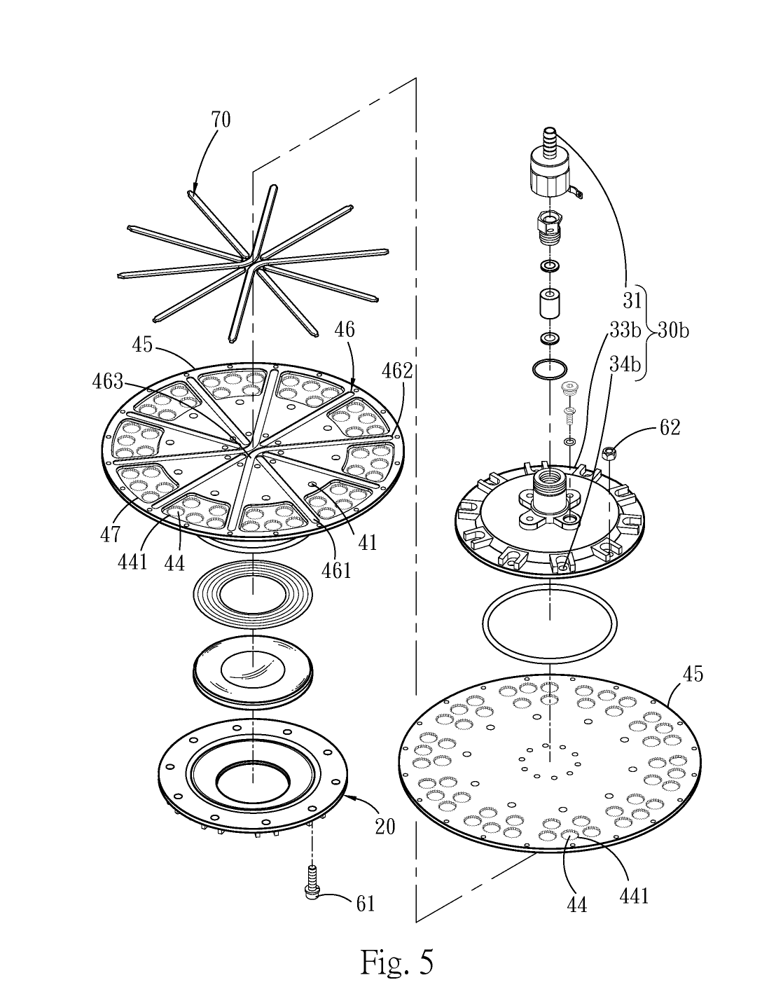

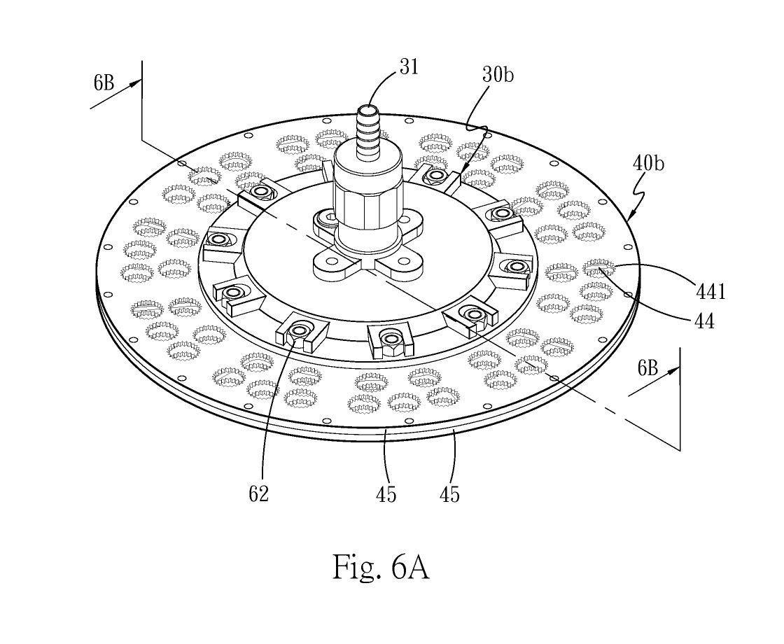

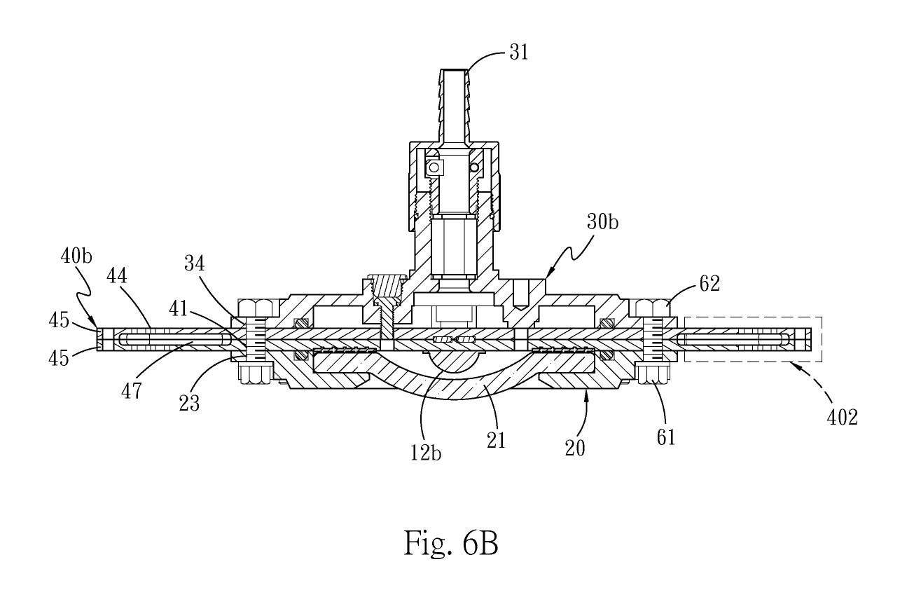

Please referring to FIGS. 5, 6A and 6B, in the second embodiment the LED explosion-proof lamp heat dissipation structure 1 includes the illumination module 10, the window frame shell 20, the lamp set shell 30b, a heat conduction disk 40b and a plurality of compact members 61. The illumination module 10, the window frame shell 20 and the compact members 61 are substantially same as that of the first embodiment, please refer to them for details if needed. In this embodiment, as shown in FIG. 6B, a single LED 12b is employed. The heat conduction disk 40b is connected to the illumination module 10. Each compact member 61 runs through one window frame connection hole 23, one installation hole 41 and one lamp set connection hole 34b to clamp the window frame shell 20 and the lamp set shell 30b at two opposite sides of the heat conduction disk 40b. After the heat conduction disk 40b has been coupled with the window frame shell 20 and the lamp set shell 30b, a heat conduction zone 401 corresponding to the projection area of the window frame shell 20 and the lamp set shell 30b is formed, and a cooling zone 402 is formed to encircle the heat conduction zone 401 at an outer side and extended in a direction remote from the center of the heat conduction disk 40b to perform heat exchange with external air.

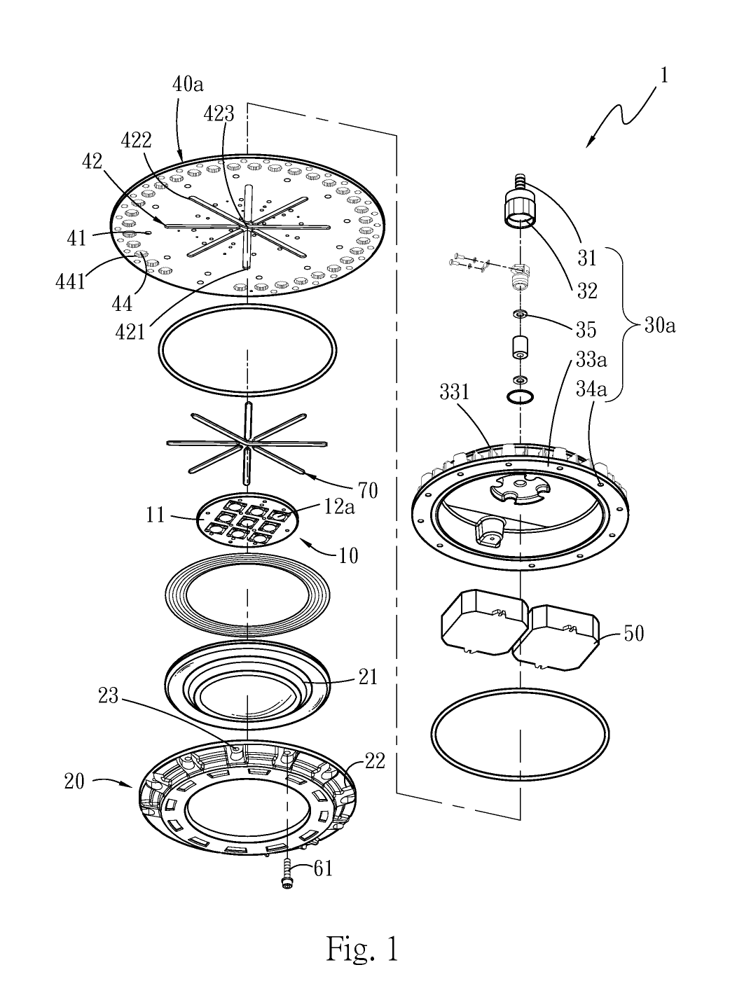

In the second embodiment the LED 12b is driven by AC power, and can be directly connected to city power 110V, 220V or other voltages without the need of adding the electric control unit 50 as the first embodiment does in FIG. 1.

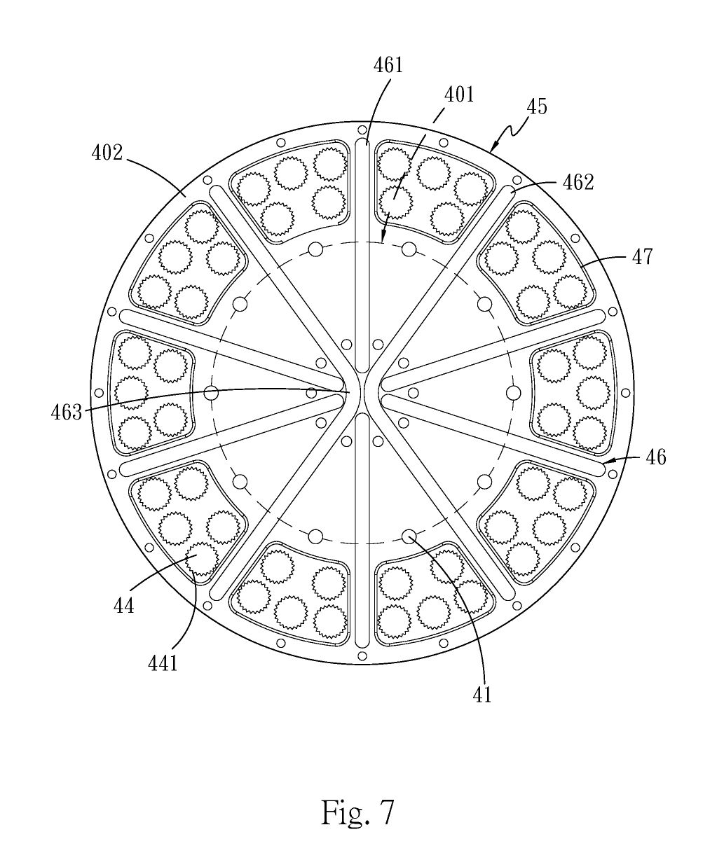

Also referring to FIG. 7, in the second embodiment the heat conduction disk 40b further includes two panels 45 which are constructed same. FIG. 7 illustrates only one of the panels 45 as an example.

Each panel 45 has an indented clamp portion 46 at one side facing the other panel 45. The clamp portion 46 includes a plurality of wedge troughs 461 originated from the center of the heat conduction disk 40b and extended radially from the center thereof. The LED explosion-proof lamp heat dissipation structure 1 further includes a plurality of heat conduction materials 70 located between the two clamp portions 46. In this embodiment the heat conduction materials 70 are clamped by the panels 45 and confined in the clamp portions 46. Waste heat generated by the LED 12b in operation can be transmitted from the base 11 to the heat conduction disk 40b, then conducted via the heat conduction materials 70 to other portions of the heat conduction disk 40b, so that the heat originally concentrated in a smaller area of the base 11 can be distributed rapidly to the heat conduction disk 40a of a larger area. Moreover, sparks that might be generated by unstable power supply or the like in the LED explosion-proof lamp heat dissipation structure 1 can be sealed between the panels 45 without in contact with the external inflammable gases. In this embodiment the heat conduction materials 70 also can be extended to the distal end of the heat conduction disk 40b to increase heat conduction area, and also can provide explosion proof effect at the same time. In addition, each clamp portion 46 also includes at least one curved wedge trough 462 which has a curved wedge section 463 passing through the center of the heat conduction disk 40b. Hence the heat conduction materials 70 passing through the highest temperature spot of the heat conduction disk 40b can efficiently transmit the waste heat to the cooling zone 402 to be dispersed in the air.

In addition, in order to get even better heat dissipation effect, in this embodiment the heat conduction disk 40b further has a plurality of cooling holes 44 located in the cooling zone 402 to encircle the heat conduction zone 401 of the heat conduction disk 40b. Each cooling hole 44 has a plurality of serrate notches 441 on the circumference thereof that can increase the surface area of the heat conduction disk 40b. The serrate notches 441 have pointed spots formed on the heat conduction disk 40a that also can improve cooling efficiency. In yet another embodiment each panel 45 has a plurality of indented cooling chambers 47 at one side faced the other panel 45 and located in the cooling zone 402 to encircle the heat conduction zone 401 (referring to FIG. 6B). The heat conduction disk 40b has a plurality of cooling holes 44 run through each cooling chamber 47. Each cooling hole 44 has a plurality of serrate notches 441 formed on the circumference thereof. Because the cooling chambers 47 are cut out portions between the panels 45, the surface area of the panels 45 increases, this can further increase the cooling efficiency.

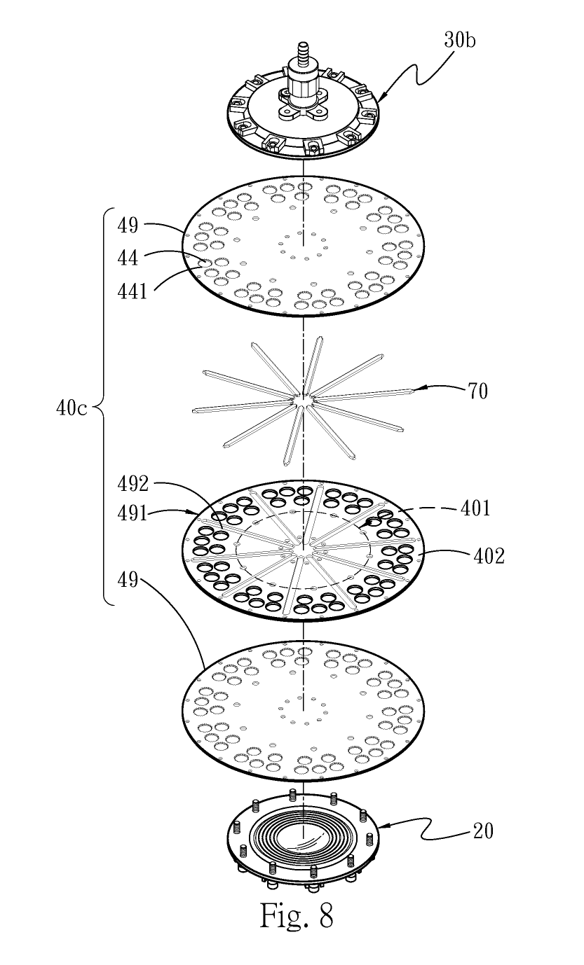

Please refer to FIG. 8 for a third embodiment of the invention. The LED explosion-proof lamp heat dissipation structure 1 in this embodiment is constructed substantially same as that of the second embodiment previously discussed. It differs merely on the heat conduction disk 40c, while the other elements such as the window frame shell 20, the lamp set shell 30b or the illumination module 10 (referring to FIG. 1) are constructed same as the second embodiment which can be referred to if needed.

In this embodiment the heat conduction disk 40c includes two clamp panels 49 and a spaced panel 491 located between the two clamp panels 49. The heat conduction disk 40c has a plurality of housing chambers 492 run through the spaced panel 491 and sealed by the two clamp panels. Each housing chamber 492 is originated from the center of the heat conduction disk 40c and extended radially from the center thereof. The LED explosion-proof lamp heat dissipation structure 1 further includes a plurality of heat conduction materials 70 located in each housing chamber. In this embodiment the spaced panel 491 is cut out and clamped at two sides by the clamp panels 49 so that the cut out portions of the spaced panel 49 form the housing chambers 492. The housing chambers 492 thus formed make fabrication easier.

To further improve cooling efficacy, the spaced panel 491 has a plurality of cooling chambers 47 run through the spaced panel 491 and sealed by the clamp panels 49 and located in the cooling zone 402 to encircle the heat conduction zone 401, and a plurality of cooling holes 44 run through each cooling chamber 47. Each cooling hole 44 has a plurality of serrate notches 441 formed on the circumference thereof. The cooling chamber 47 can be formed in a circular aperture, or a substantial fan shape as shown in FIG. 7, without restriction. The cooling chambers 47 are cut out portions between the heat conduction materials 70, hence can increase the surface area of the spaced panel 491 to further improve cooling efficacy.

As a conclusion, the invention can conduct and disperse the waste heat generated by the LED from the base of a smaller area to the heat conduction disk of a larger area, and has the cooling zone formed by extending the heat conduction disk to outer side to be in contact with the air, hence can disperse the waste heat faster. Through sealed coupling of the lamp set shell, the heat conduction disk and the window frame shell the LED explosion-proof lamp heat dissipation structure can achieve explosion proof effect as desired. In addition, through the heat conduction materials the waste heat generated by the LED can be rapidly dispersed widely to the heat conduction disk. Through the cooling holes cooling efficiency can be improved further. Thus this invention can provide a greater cooling efficiency per unit of volume than the conventional techniques, and replace the conventional assembly structure of cooling via point contact between the heat conduction materials and the cooling fins, therefore can reduce the size and weight of the LED explosion-proof lamp heat dissipation structure.

What is claimed is:

1. A heat dissipation structure for an LED explosion-proof lamp, comprising:
an illumination module including a base and at least one light-emitting diode located on the base;
a heat conduction disk which is installed on the base and includes a plurality of installation holes along the circumference of the base;
a window frame shell which is located at one side of the illumination module where the light-emitting diode is located and includes a light permeable portion corresponding to each light-emitting diode, a window frame encircled the light permeable portion and a plurality of window frame connection holes located on the window frame corresponding to the installation holes;
a lamp set shell which is located at another side of the illumination module opposite to the window frame shell and includes a casing portion in contact with the heat conduction disk after assembly and a plurality of lamp set connection holes located on the casing portion corresponding to the window frame connection holes; and
a plurality of compact members each run through one window frame connection hole, one installation hole and one lamp set connection hole that correspond to each other to press and hold the window frame shell and the lamp set shell at two opposite sides of the heat conduction disk;
wherein the heat conduction disk has a heat conduction zone corresponding to a projection location of the window frame shell and the lamp set shell after has been coupled with the window frame shell and the lamp set shell, and a cooling zone encircled the heat conduction zone at an outer side and extended in a direction remote from the center of the heat conduction disk to perform heat exchange with external air.

2. The heat dissipation structure for an LED explosion-proof lamp of claim 1, wherein the heat conduction disk includes a housing portion at one side faced the base that includes a plurality of grooves originated from the center of the heat conduction disk and extended radially from the center thereof, the LED explosion-proof lamp heat dissipation structure further including a plurality of heat conduction materials located in the grooves.

3. The heat dissipation structure for an LED explosion-proof lamp of claim 2, wherein the housing portion includes at least one curved groove which has a curved section passing through the center of the heat conduction disk.

4. The heat dissipation structure for an LED explosion-proof lamp of claim 2, wherein the housing portion includes an allowance gap located in the heat conduction zone and spaced from the window frame shell.

5. The heat dissipation structure for an LED explosion-proof lamp of claim 4, wherein the heat conduction disk includes a plurality of cooling holes encircled the heat conduction zone, each cooling hole including a plurality of serrate notches formed on the circumference thereof.

6. The heat dissipation structure for an LED explosion-proof lamp of claim 1, wherein the heat conduction disk includes two panels each has an indented clamp portion at one side faced the other panel, each clamp portion including a plurality of wedge troughs originated from the center of the heat conduction disk and extended radially from the center thereof, the LED explosion-proof lamp heat dissipation structure further including a plurality of heat conduction materials located between the two clamp portions.

7. The heat dissipation structure for an LED explosion-proof lamp of claim 6, wherein each clamp portion includes at least one curved wedge trough which has a curved wedge trough section passing through the center of the heat conduction disk.

8. The heat dissipation structure for an LED explosion-proof lamp of claim 6, wherein each panel includes a plurality of cooling chambers at one side faced the other panel and located in the cooling zone to encircle the heat conduction zone, the heat conduction disk including a plurality of cooling holes each has a plurality of serrate notches formed on the circumference thereof.

9. The heat dissipation structure for an LED explosion-proof lamp of claim 1, wherein the heat conduction disk includes two clamp panels and a spaced panel located between the two clamp panels, the spaced panel including a plurality of housing chambers run through the spaced panel and sealed by the clamp panels, each housing chamber originated from the center of the heat conduction disk and extended radially from the center thereof, the LED explosion-proof lamp heat dissipation structure further including a plurality of heat conduction materials located in the housing chambers.

10. The heat dissipation structure for an LED explosion-proof lamp of claim 9, wherein the heat conduction disk includes a plurality of cooling holes located in the cooling zone to encircle the heat conduction zone and the heat conduction materials, each cooling hole including a plurality of serrate notches formed on the circumference thereof.

11. The heat dissipation structure for an LED explosion-proof lamp of claim 9, wherein the spaced panel includes a plurality of cooling chambers located in the cooling zone and run through the spaced panel and sealed by the clamp panels to encircle the heat conduction zone, and a plurality of cooling holes each has a plurality of serrate notches formed on the circumference thereof.

12. The heat dissipation structure for an LED explosion-proof lamp of claim 1, wherein the heat conduction disk includes a plurality of cooling holes located in the cooling zone to encircle the heat conduction zone, each cooling hole including a plurality of serrate notches formed on the circumference thereof.

13. The heat dissipation structure for an LED explosion-proof lamp of claim 1 further including a plurality of expansion fins located on the cooling zone at one side of the heat conduction disk faced the lamp set shell.
